(19) United States
(12) Patent Application Publication
(10) Pub. No.: US 2015/0294617 A1
(43) Pub. Date: Oct. 15, 2015

(54) IMAGE DATA OUTPUT CONTROL APPARATUS AND METHOD USING CURRENT CONSUMPTION

(71) Applicant: Samsung Electronics Co., Ltd., Suwon-si (KR)

(72) Inventor: Sung Jin YOON, Suwon-si (KR)

(21) Appl. No.: 14/518,284

(22) Filed: Oct. 20, 2014

(30) Foreign Application Priority Data
Apr. 9, 2014 (KR) 10-2014-0042187

(51) Int. Cl. G09G 3/32

(52) U.S. Cl. CPC G09G 3/3225; G09G 2320/0626; G09G 2330/021; G09G 2330/028

(57) ABSTRACT

An image data output control apparatus and method using current consumption are provided. The control apparatus includes a control module configured to detect current consumption for each pixel for at least one image data, to calculate a current consumption value per unit time, and to control an output of the image data, and an output module configured to output the image data.

### CROSS-REFERENCE TO RELATED APPLICATION(S)

This application claims the benefit under 35 U.S.C. §119(a) of a Korean patent application filed on Apr. 9, 2014 in the Korean Intellectual Property Office and assigned Serial number 10-2014-0042187, the entire disclosure of which is hereby incorporated by reference.

### TECHNICAL FIELD

The present disclosure relates to an image data output control apparatus and method using current consumption. More particularly, the present disclosure relates to a method for an image data output control that, when at least one piece of image data is output, current consumption is detected for each pixel for the image data and the output is controlled.

### BACKGROUND

Typically, when the remaining charge of a battery is not greater than a threshold value during the outputting of data, an electronic device performs battery power saving by adjusting the brightness of a display device.

Since a typical electronic device performs battery power saving by simply lowering the brightness of an output module when a remaining charge of a battery is not greater than a threshold value, a user that has been viewing the electronic device is inconvenienced.

Therefore, a need exists for an image data output control apparatus and method using current consumption, which is able to control an image data output method using characteristics of an output module having different current consumptions according to a Red, Green, and Blue (RGB) value for each pixel of the image data.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an image data output control apparatus and method using current consumption, which is able to control an image data output method using characteristics of an output module having different current consumptions according to a Red, Green, and Blue (RGB) value for each pixel of the image data.

Another aspect of the present disclosure is to provide an image data output control apparatus and method using current consumption, which is able to control a method of outputting image data according to a current consumption value per unit time of the image data and a remaining power value of an electronic device.

In accordance with an aspect of the present disclosure, am apparatus for controlling image data output using current consumption is provided. The apparatus includes a control module configured to detect current consumption for each pixel for at least one image data, to calculate a current consumption value per unit time, and to control an output of the image data, and an output module configured to output the image data.

In accordance with another aspect of the present disclosure, a method for controlling image data output using current consumption is provided. The method includes detecting, by a control module, current consumption for each pixel for at least one image data, calculating by the control module, a current consumption value per unit time based on the current consumption, and controlling, by the control module, an output of the image data according to the current consumption value.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a main configuration of an image data output control apparatus according to an embodiment of the present disclosure.

FIG. 2 is a flowchart illustrating an image data output control method according to an embodiment of the present disclosure.

FIGS. 3A, 3B, 3C and 3D are screen views illustrating an image data arranging method according to current consumption of image data according to an embodiment of the present disclosure.

FIGS. 4A, 4B, and 4C are screen views illustrating an image data output according to rotation of an electronic device in a battery power saving mode according to an embodiment of the present disclosure.

FIGS. 5A, 5B, 5C, and 5D are screen views illustrating a method of controlling an image data output according to an output control signal in a battery power saving mode according to an embodiment of the present disclosure.

FIGS. 6A, 6B, and 6C are screen views illustrating a slide show execution process in a battery power saving mode according to an embodiment of the present disclosure.

FIGS. 7A, 7B, 7C, and 7D are screen views illustrating an image data change with remaining power in a battery power saving mode according to an embodiment of the present disclosure.

FIG. 8 is a block diagram illustrating an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modification of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The terms “include,” “comprise,” “including,” or “comprising” used herein indicate disclosed functions, operations, or existence of elements but does not exclude other functions, operations or elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

In various embodiments of the present disclosure, the meaning of the term “or” used herein includes any combination of the words connected by the term “or”. For example, the expression “A or B” or “at least one of A or/and B” may indicate A, B, or both A and B.

The terms such as “first”, “second”, and the like used herein may refer to various elements of various embodiments, but do not limit the elements. For example, such terms do not limit the order and/or priority of the elements. Furthermore, such terms may be used to distinguish one element from another element. For example, “a first user device” and “a second user device” indicate different user devices. For instance, without departing the scope of the present disclosure, a first element may be named as a second element, and similarly, a second element may be named as a first element.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

The terminology used herein is not for limiting the present disclosure but for describing specific various embodiments of the present disclosure. The terms of a singular form may include plural forms unless otherwise specified. As used herein, the singular forms “a,” “an” and “the” are intended to include the plural forms as well, unless the context clearly indicates otherwise.

Unless otherwise defined, the terms used herein, including technical or scientific terms, have the same meanings as understood by those skilled in the art. The general terms used herein should be interpreted according to the definitions in the dictionary or in the context and should not be interpreted as an excessively contracted meaning.

An electronic device according to the present disclosure may be a device including a communication function. For example, the electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a Motion Pictures Expert Group (MPEG-1 or MPEG-2) Audio Layer 3 (MP3) player, a mobile medical equipment, a camera, or a wearable device (for example, glasses, such as a Head-Mounted-Device (HMD), electronic clothes, electronic bracelet, electronic collar, appcessory, electronic tattoo, or smart watch, and the like).

According to various embodiments of the present disclosure, an electronic device may be a smart home appliance having communication functions. The smart home appliance may include at least one of, for example, a Television (TV), a Digital Versatile Disc (DVD) player, an audio, a refrigerator, an air conditioner, a cleaner, an oven, a microwave oven, a washing machine, an air cleaner, a set-top box, a TV box (e.g., a Samsung HomeSync™, an Apple TV™, a Google TV™, and the like), a game console, an electronic dictionary, an electronic key, a camcorder, an electronic picture frame, and the like.

According to various embodiments of the present disclosure, an electronic device may include at least one of various medical devices (e.g., Magnetic Resonance Angiography (MRA), Magnetic Resonance Imaging (MRI), Computed Tomography (CT), a camcorder, an ultrasound imaging, and the like), a navigation device, a Global Positioning System (GPS) receiver, an Event Data Recorder (EDR), a Flight Data Recorder (FDR), an automotive infotainment device, a marine electronic equipment (such as a gyro compass, a marine navigation system, and the like), avionics, a security equipment, an automotive head unit, an industrial or domestic robot, an Automatic Teller Machine (ATM) in a financial institution, and Point Of Sales (POS) in a shop.

According to various embodiments of the present disclosure, an electronic device may include at least one of furniture or building/structure including a communication function, an electronic board, an electronic signature receiving device, a projector, or other measuring instruments (such as water, electricity, gas, or propagation measurement devices, and the like). An electronic device according to the present disclosure may be a combination of one or more of the above-described various electronic devices. In addition, an electronic device may be a flexible device. Furthermore, it may be obvious to those skilled in the art that an electronic device is not limited to the above-described devices.

Hereinafter, connection members and electronic devices applicable to an electronic device are described with reference to the accompanying drawings. The term “user” used in various embodiments of the present disclosure may refer to a person who uses an electronic device or a device (for example, an artificial intelligent electronic device) which uses an electronic device.

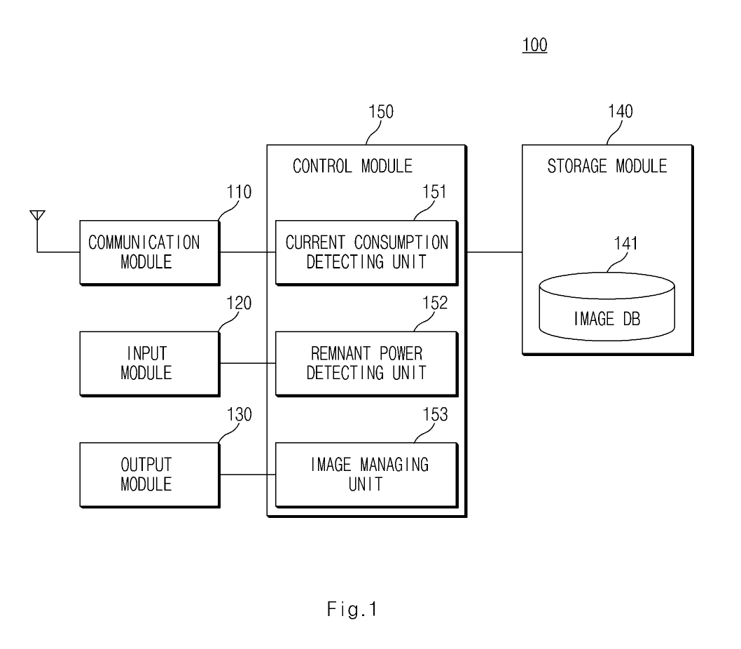

FIG. 1 is a block diagram illustrating a main configuration of an image data output control apparatus according to an embodiment of the present disclosure.

Referring to FIG. 1, an image data output control apparatus 100 (hereinafter referred to as electronic apparatus 100) may include a communication module 110, an input module 120, an output module 130, a storage module 140, and a control module 150. The storage module 140 may include an image DataBase (DB) 141, and the control module 150 may include a current consumption detecting unit 151, a remaining power detecting unit 152 and an image managing unit 153.

The communication module 110 may establish communication between the electronic apparatus 100 and an external device (e.g., the electronic device (not shown), or a server device (not shown)). The communication module 110 may communicate with the external device through wireless or wired communication. The wired communication may include at least one of Universal Serial Bus (USB) communication, High Definition Multimedia Interface (HDMI) communication, Recommended Standard 232 (RS-232 communication, and Plain Old Telephone Service (POTS) communication. The wireless communication may include at least one of a Wireless Fidelity (WiFi) communication, a Bluetooth (BT) communication, a Near Field Communication (NFC), and a cellular communication (e.g., LTE, LTE-A, CDMA, WCDMA, UMTS, WiBro, or GSM). The communication module 110 may receive at least one image data from an external device through the wired or wireless communication and provide it to the control module 150.

The input module 120 may create an operation signal for operating the electronic apparatus 100 according to an input from outside and provide the operation signal to the control module 150. The input module 120 may create an arrangement signal for arranging the image data based on current consumption that is consumed when an image data list for at least one image data is output. The input module 120 may create an entering signal for entering a battery power saving mode. The input module 120 may create an enlarging signal for enlarging image data displayed on the output module 130. The input module 120 may create an entering signal for detecting stored image data in a slide show type. The input module 120 may include an input device, such as a key button, a keyboard, a key pad, a touch pad, a touch screen, and the like.

The output module 130 may display various screens operated under a control of the control module 150. The output module 130 may be formed of a touch screen using an Active-Matrix Organic Light-Emitting Diode (AMOLED) display. When including the touch screen, the input module 120 may simultaneously execute a role of the input module 120. When the output module 130 includes the AMOLED display, current consumptions may be differed according to Red, Green, and Blue (RGB) values (hereinafter referred to as pixel values) corresponding to pixels of the output image data. When including the touch screen, the input module 120 may create various input signals for controlling the operation of the electronic apparatus 100. The output module 130 may output a current consumption value of image data and a remaining power amount of the battery, which are output under a control of the control module 150.

The storage module 140 may store a program or an application for operating the electronic apparatus 100. The storage module 140 may store at least one image data obtained at a camera module (not shown) and store at least one image data received from the external device in the image DB 141. The storage module 140 may receive the current consumption value per unit time for each image data from the control module 150, and map it to each image data stored in the image DB 141 and store the mapped result. At this point, the storage module 140 may store a current consumption value when the image data is output as a thumbnail, a current consumption value when the image data is cropped and output, or a current consumption value when the image data is output in full size to the output module 130. The full size may respectively indicate that the electronic apparatus 100 is in a landscape mode or in a portrait mode.

The control module 150 may detect the current consumption for each pixel for at least one image data, calculate a current consumption value per unit time and control an output of the image data. When an arrangement signal for arranging at least one image data stored in the storage module 140 is received from the input module 120 or the output module 130, the current consumption detecting unit 151 of the control module 150 may arrange the image data based on a received arrangement criterion. When the arrangement criterion is confirmed as the current consumption, the current consumption detecting unit 151 may detect current consumption for each pixel for at least one image data stored in the storage module 140. The current consumption detecting unit 151 may calculate the current consumption value per unit time based on the detected current consumption. For example, when the output module 130 is an AMOLED display, the current consumptions may be differed according to pixel values of the image data. Therefore, the current consumption detecting unit 151 may detect current consumption according to each pixel value forming the image data. The current consumption detecting unit 151 may respectively calculate a current consumption value when the image data is displayed in full size on the output module 130, a current consumption value when the image data is displayed as a thumbnail, and a current consumption value when the image data is displayed as the cropped image data. At this point, the full size may respectively indicate that the electronic apparatus 100 is in a landscape mode or in a portrait mode.

When an entering signal for entering a power saving mode is received from the input module 120 or the output module 130, the remaining power detecting unit 152 may detect remaining power of the battery. The image managing unit 153 may control an image data output according to at least one of the current consumption value per unit time of the image data, the remaining power of the battery, and an output control signal.

When outputting the image data on the output module 130, the image managing unit 153 may overlay, on the image data, current consumption of the image data detected in the current consumption detecting unit 151 and remaining power detected in the remaining power detecting unit 152, and output the overlaid result. The case where the image data is output to the output module 130 may be the case where the image data is output as an idle background screen, or the case where stored image data or image data received from the external device is detected. In the case where the image managing unit 153 outputs the stored image data or the image data received from the external device, the image data may be output in full size on the output module 130 and output in a thumbnail type or in a cropped type.

In an embodiment of the present disclosure, when the image data is output as the idle background screen, the image managing unit 153 may control an output of image data according to remaining power of the battery detected in the remaining power detecting unit 152. When the remaining power is less than a threshold value, the image managing unit 153 may change the image data into other image data having a lesser current consumption value and output the changed image data. When the remaining power is less than the threshold value, the image managing unit 153 may contract the image data for reducing the current consumption value and output the contracted image data. When the remaining power is less than the threshold value, the image managing unit 153 may extract at least one image data having a current consumption value less than that of the image data from the storage module 140. The image managing unit 153 may output a list for the at least one extracted image data to the output module 130. The image managing unit 153 may change image data selected from the output image data list into an idle background screen and output the background screen.

In an embodiment of the present disclosure, when outputting image data to the output module 130, the image managing unit 153 may control an image data output according to at least one of current consumption detected in the current consumption detecting unit 151, remaining power detected in the remaining power detecting unit 152, and an image data output control signal. When detecting rotation of the electronic apparatus 100, the image managing unit 153 may rotate image data output on the output module 130 in a direction that the electronic apparatus 100 is rotated, and output the image data. To this end, the electronic apparatus 100 may include a rotation detecting sensor (not shown) for detecting the rotation of the electronic apparatus 100.

When a signal for enlarging the image data output on the output module 130 is received, the remaining power detecting unit 152 may detect whether remaining power of the battery is not less than a threshold value. When the remaining power is not less than the threshold value, the image managing unit 153 may enlarge a certain part of the image data and output the enlarged image data on the output module 130. At this point, when the remaining power is less than the threshold value, the current consumption detecting unit 151 may detect a current consumption value per unit time of the image data output on the output module 130. When a signal for enlarging the certain part of the image data is received from outside, the current consumption detecting unit 151 may calculate a current consumption value when the certain part of the image data is enlarged and output. When the current consumption value of the enlarged certain part is not less than the threshold value, the image managing unit 153 may control to enlarge image data and output a message popup window notifying that the image data is not able to be enlarged due to battery shortage on the output module 130.

When a signal for rotating the image data output on the output module 130 is received, for example, when rotation of the electronic apparatus 100 is detected, the remaining power detecting unit 152 may detect whether the remaining power of the battery is not less than a threshold value. When the remaining power is not less than the threshold value, the image managing unit 153 may rotate the image data and output in full size on the output module 130. At this point, when the remaining power is less than the threshold value, the current consumption detecting unit 151 may detect a current consumption value per unit time of the image data when rotating the image data and outputting it in full size on the output module 130. When the current consumption value detected in the current consumption detecting unit 151 is less than the threshold value, the image managing unit 153 may rotate the image data and output it in full size on the output module 130. When the current consumption value detected in the current consumption detecting unit 151 is not less than the threshold value, the image managing unit 153 may rotate the image data and control an output in full size, and may output the message popup window notifying that the image data is not able to be rotated and output in full size due to battery shortage on the output module 130.

In an embodiment of the present disclosure, when a signal for detecting at least one image data stored in the storage module 140 through a slide show is received, the current consumption detecting unit 151 may crop a region whose current consumption value per unit time is the least in each image data. At this point, the region cropped in the image data may be randomly set. The remaining power detecting unit 152 may compare remaining power of the battery with the threshold value. When the remaining power of the battery is not less than the threshold value, the image managing unit 153 may output the cropped image data in a slide show type. When the remaining power of the battery detected in the remaining power detecting unit 152 is less than the threshold value, the current consumption detecting unit 151 may detect the current consumption value for the at least one cropped image data for performing the slide show. When the detected current consumption value is less than the threshold value, the image managing unit 153 may output the cropped image data in the slide show type. When the current consumption value is not lower than the threshold value, the image managing unit may output a message popup window notifying that the image data is not able to be output in the slide show type due to remaining power shortage of the battery.

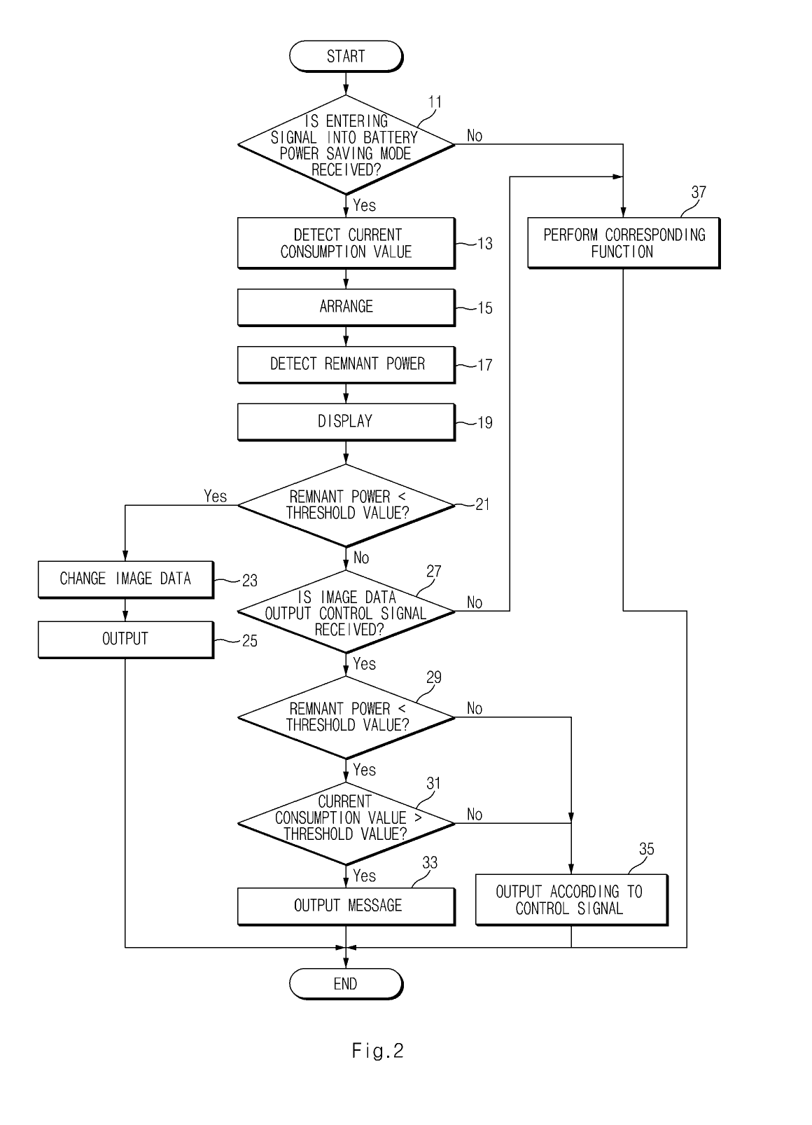

FIG. 2 is a flowchart illustrating an image data output control method according to an embodiment of the present disclosure.

Referring to FIGS. 1 and 2, in operation 11, when an entering signal to a battery power saving mode is received from the input module 120, the control module 150 may perform operation 13. When the entering signal is not received in operation 11, the control module 150 may perform operation 37. In operation 37, the control module 150 may maintain an idle state or continuously perform a function being performed.

In operation 13, the control module 150 may detect current consumption for each pixel for at least one image data stored in the storage module 140. For example, the control module 150 may detect RGB values of pixels for the image data and current consumption for each pixel based on the RGB values, and, based on this, detect a current consumption value per unit time. At this point, the control module 150 may detect a current consumption value when the image data is displayed in a thumbnail type, current consumption values at the time of being displayed in full size in cases where the output module 130 is in a landscape mode or in a portrait mode, and a current consumption value of a cropped region when a slide show is displayed. The cropped region may be a region in which a current consumption value thereof per unit time is the least in the image data.

In operation 15, the control module 150 may arrange at least one image data based on the detected current consumption value. When the image data is arranged in a type of at least one of image data in a thumbnail type, cropped image data, and image data output in full size on the output module 130, the control module 150 may detect the detected current consumption value and arrange the image data.

In operation 17, the control module 150 may detect remaining power of the electronic apparatus 100. In operation 19, the control module 150 may display image data set as an idle background screen on the output module 130. At this point, the control module 150 may display the current consumption value of the image data and the remaining power on a part of the image data in an overlay type.

In operation 21, the control module 150 may detect whether the remaining power is less than a threshold value. As a detected result of operation 21, when the remaining power is less than the threshold value, the control module 150 may proceed to operation 23, and convert the image data. The control module 150 may convert the image data to have a current consumption value less than the image data displayed on the output module 130. The control module 150 may contract image data displayed on the output module 130. The control module 150 may display a list of image data having current consumption value less than the image data displayed on the output module 130. At this point, the control module 150 may receive a selection signal for specific image data from the image data list. In operation 25, the control module 150 may output the image data converted in operation 23 to the output module 130.

In operation 21, when the remaining power is not less than a threshold value, the control module 150 may proceed to operation 27. In operation 27, the control module 150 may detect an output control signal of the image data. In operation 27, when the output control signal is received, the control module 150 may perform operation 29. When the output control signal is not received, the control module 150 may perform operation 37. In operation 29, the control module 150 may detect that the remaining power is less than a threshold value. As a detected result of operation 29, when the remaining power is less than the threshold value, the control module 150 may perform operation 31. When the remaining power is not less than the threshold value, the control module 150 may perform operation 35. In operation 35, when the output control signal received in operation 27 is a signal for rotating the electronic apparatus 100 in order to rotate the image data, the image data is rotated according to a rotation direction of the electronic apparatus 100 and output on the output module 130. When the output control signal received in operation 27 is a signal for enlarging the image data, the control module 150 may enlarge the image data according to a ratio of an enlargement signal and output to the output module 130. When the output control signal received in operation 27 is a signal for detecting the image data in a slide show type, the control module 150 may output the cropped and arranged image data on the output module 130 in the slide show type.

In operation 29, when the remaining power is less than the threshold value, in operation 31, the control module 150 may compare, with a threshold value, a current consumption value when the image data is output in correspondence to the output control signal. As the comparison result, when the current consumption value is greater than a threshold value, the control module 150 may perform operation 33. When the current consumption value is less than the threshold value, the control module 150 may perform operation 35. In operation 33, the control module 150 may output, on the output module 130, a message notifying that the image data output is not controllable due to shortage of the remaining power of the battery.

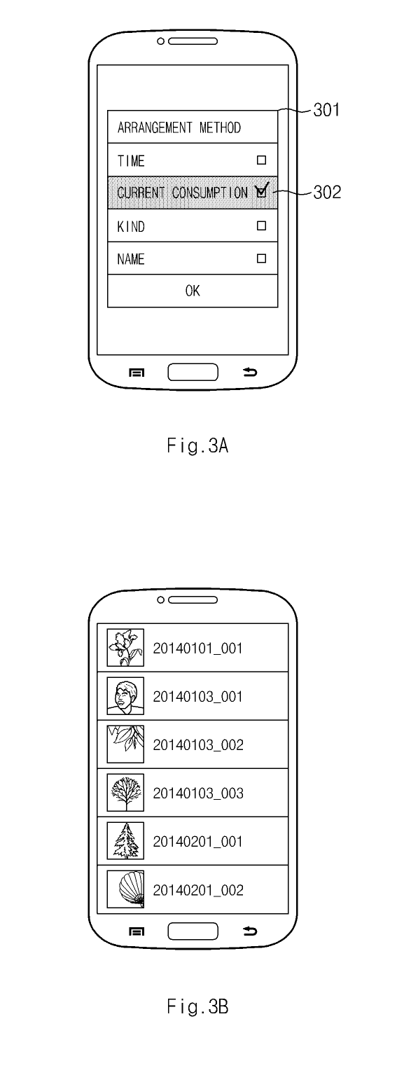

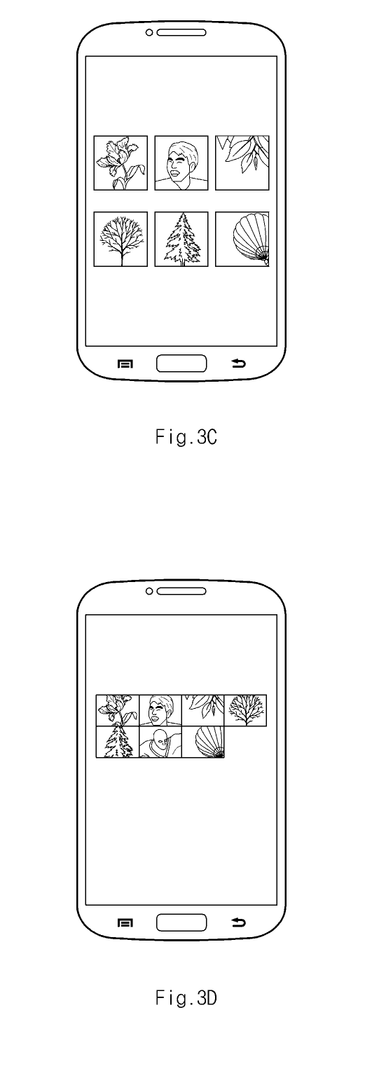

FIGS. 3A, 3B, 3C, and 3D are screen views illustrating an image data arranging method according to current consumption of image data according to an embodiment of the present disclosure.

Referring to FIGS. 1 and 3A, 3B, 3C, and 3D, when the electronic apparatus 100 enters a menu for setting an arrangement criterion of image data stored in the storage module 140 through an external input, a message popup window as a reference numeral 301 of FIG. 3A may be displayed on the output module 130. When the user selects current consumption corresponding to a reference numeral 302 and an ok button, the electronic apparatus 100 may set the current consumption as the arrangement criterion of the image data. As shown in FIG. 3A, when the arrangement criterion of the image data is set, the electronic apparatus 100 may arrange the image data based on the current consumption as shown in FIGS. 3B, 3C, and 3D.

In an embodiment of the present disclosure, when arranging the image data in the thumbnail type, the electronic apparatus 100 may calculate a current consumption value per unit time of the thumbnail. The electronic apparatus 100 may arrange the image data in the thumbnail type based on the calculated current consumption value and display as shown in FIG. 3B.

In an embodiment of the present disclosure, when arranging the image data in full size type, the electronic apparatus 100 may calculate a current consumption value per unit time of the full size. The electronic apparatus 100 may arrange the image data in full size based on the calculated current consumption value and display as shown in FIG. 3C.

In an embodiment of the present disclosure, when arranging the image data in a cropped type in order to detect the image data through a slide show, the electronic apparatus 100 may calculate a current consumption value per unit time of the cropped image data. At this point, the electronic apparatus 100 may detect a current consumption value for each pixel of the image data and crop a region where the current consumption thereof is the least in the image data. The electronic apparatus 100 may arrange the cropped image data based on the calculated current consumption values and display as shown in FIG. 3D.

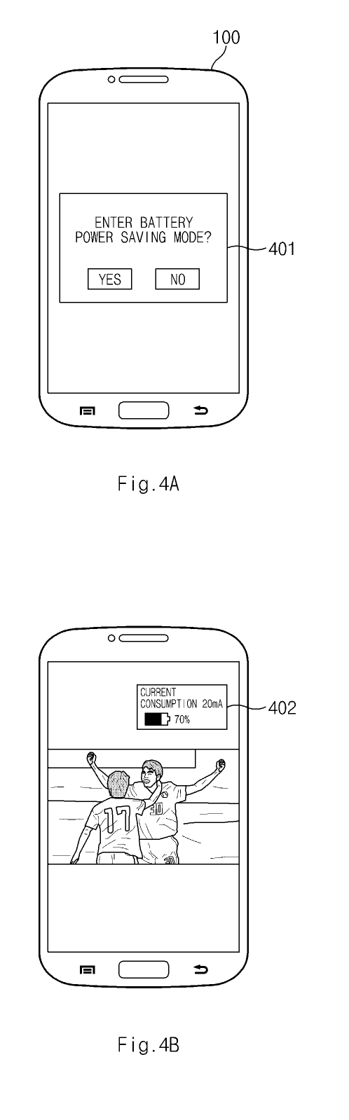

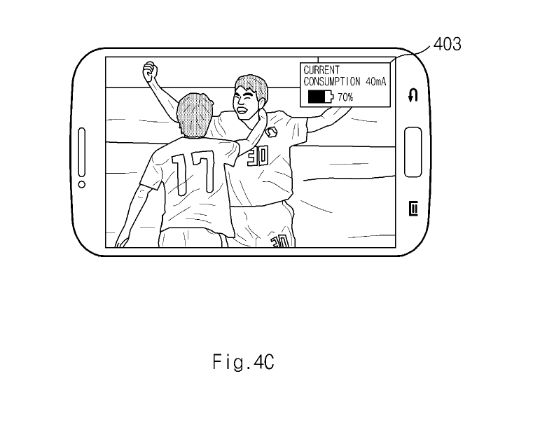

FIGS. 4A, 4B, and 4C are screen views illustrating image data output according to rotation of an electronic device in a power saving mode of a battery according to an embodiment of the present disclosure.

Referring to FIGS. 1, 3A, 3B, 3C, and 3D, and 4A, 4B, and 4C, when selecting a menu for entering a power saving mode of a battery through an external input, the electronic apparatus 100 may display a message popup window as a reference numeral 401 of FIG. 4A on the output module 130. When YES is selected in the message popup window of the reference numeral 401, the electronic apparatus 100 may enter the power saving mode of the battery. When NO is selected in the message popup window, the electronic apparatus 100 may return to a previous screen.

The electronic apparatus 100 entering the power saving mode of the battery may arrange the image data based on a current consumption value as in FIGS. 3B, 3C, and 3D. The electronic apparatus 100 may display current consumption of the image data and remaining power of the battery on the image data that is set as an idle background screen as a reference numeral 402 of FIG. 4B. When the electronic apparatus 100 is rotated from FIGS. 4B and 4C, the image data may be rotated and enlarged to as FIG. 4C. At this point, the electronic apparatus 100 may display current consumption of the image data and remaining power of the battery as a reference numeral 403. The current consumption of the image data may be differed when an identical image data is displayed as in FIGS. 4B and 4C. The electronic apparatus 100 may respectively calculate a current consumption value of the image data displayed on the output module 130 when the electronic apparatus 100 is in the landscape mode or in the portrait mode. At this point, the current consumption value is represented in mA, but may be represented in Watt.

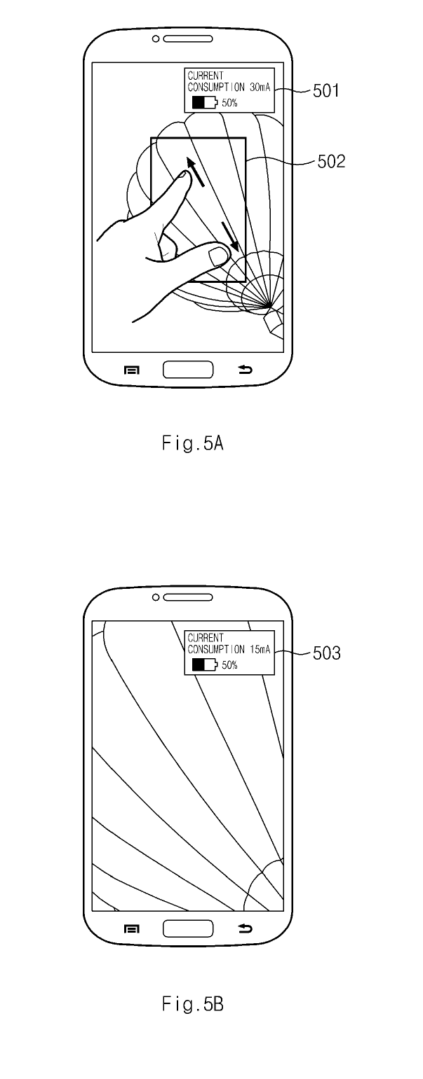

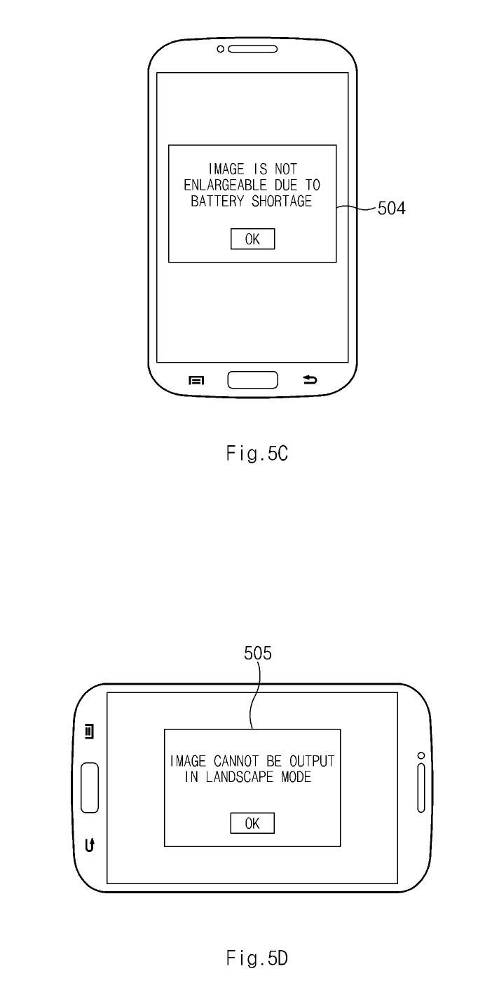

FIGS. 5A, 5B, 5C, and 5D are screen views illustrating a method of controlling an image data output according to an output control signal in a battery power saving mode according to an embodiment of the present disclosure.

Referring to FIGS. 1 and 5A, 5B, 5C, and 5D, in a state where the image data is output as in FIG. 5A, the electronic apparatus 100 may display current consumption of the image data output on the output module 130 and remaining power of the battery as a reference numeral 501. When a signal for enlarging a certain part of the image data is input from the user as a reference numeral 502 of FIG. 5A, the electronic apparatus 100 may detect whether the remaining power of the battery is not lower than a threshold value. When the remaining power is not lower than the threshold value, the electronic apparatus 100 may enlarge the image data as in FIG. 5B. The electronic apparatus 100 may calculate a current consumption value of a region enlarged and output on the output module 130, detect current remaining power of the battery and display as a reference numeral 503.

When the signal for enlarging the certain part of the image data is received from the user as in FIG. 5A and the detected remaining power of the battery is less than a threshold value, the electronic apparatus 100 may calculate a current consumption value of a region (reference numeral 502) to be enlarged and output. When image data of the region corresponding to the reference numeral 502 is enlarged and the current consumption value is not lower than the threshold value, the electronic apparatus 100 may output a message popup window notifying that the image data is not enlargeable due to shortage of the remaining power of the battery as a reference numeral 504 of FIG. 5C. When the current consumption value of the reference numeral 502 is less than the threshold value, the electronic apparatus 100 may enlarge the image data like FIG. 5B and output the enlarged image data.

When the electronic apparatus 100 is detected as rotated as FIG. 5D, the electronic apparatus 100 may detect whether the remaining power of the battery is not lower than the threshold value. At this time, when the remaining power of the battery is not lower than the threshold value, the electronic apparatus 100 may rotate the image data and output it on the output module 130. When the remaining power of the battery is less than the threshold value, the electronic apparatus 100 may calculate a current consumption value of the image data to be rotated and output. When the calculated current consumption value is not less than a threshold value, the electronic apparatus 100 may output a message popup window notifying that the image data is not able to be output in a landscape mode due to shortage of remaining power of the battery as a reference numeral 505 of FIG. 5D. When the calculated current consumption is less than the threshold value, the electronic apparatus 100 may rotate the image data and output it on the output module 130.

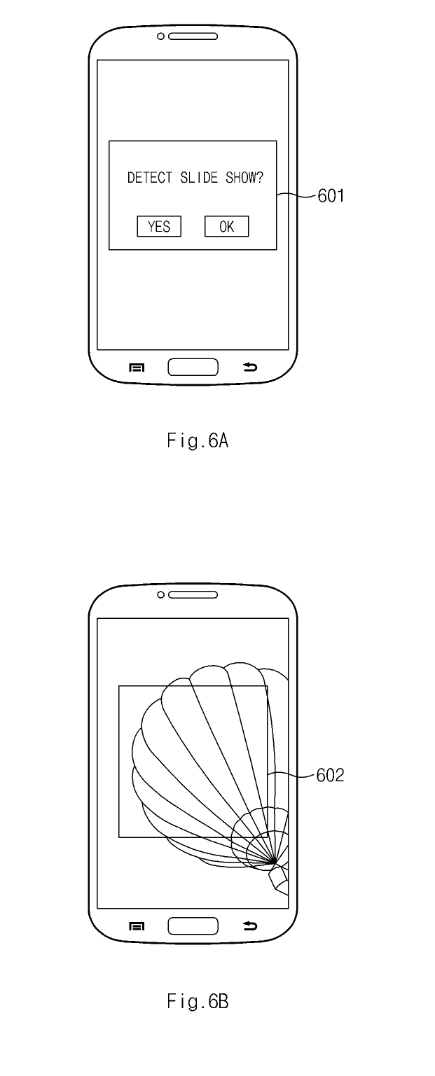

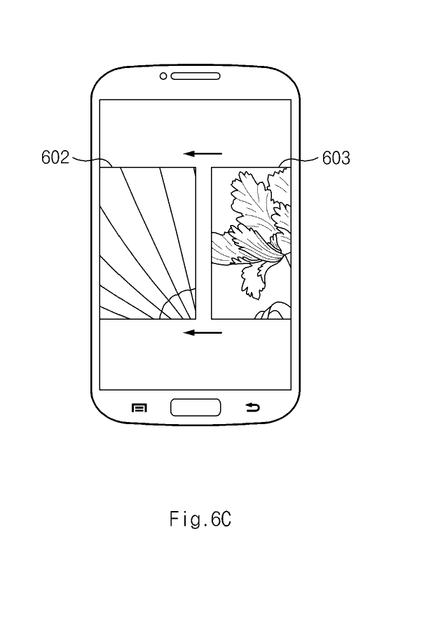

FIGS. 6A, 6B, and 6C are screen views illustrating a process of executing a slide show in a battery power saving mode according to an embodiment of the present disclosure.

Referring to FIGS. 1 and 6A, 6B, and 6C, when the electronic apparatus 100 selects a menu for detecting a slide show for at least one stored image data through an external input, a message popup window as a reference number 601 of FIG. 6A may be displayed on the output module 130. When YES is selected in the message popup window as the reference numeral 601, the electronic apparatus 100 may enter a slide show mode. At this point, when NO is selected in the message popup window, the electronic apparatus 100 may return to a previous screen. The electronic apparatus 100 may crop a region where a current consumption value per unit time is the least based on a current consumption value for each pixel for at least one image data.

When the menu is selected for detecting a slide show, the electronic apparatus 100 may compare the remaining power of the battery with a threshold value. When the remaining power of the battery is not less than the threshold value, the electronic apparatus 100 my output the cropped image data as the reference numeral 602 in a slide show type as in FIG. 6C. At this time, a reference numeral 603 may be image data that a region where a current consumption value is the least is cropped in image data different from the image data shown in FIG. 6B.

When a menu is selected for detecting the slide show, the electronic apparatus 100 may compare the remaining power of the battery with a threshold value. When the remaining power of the battery is not lower than the threshold value, the electronic apparatus 100 may output the cropped image data as a reference numeral 602 in a slide show type as FIG. 6C. At this point, the reference numeral 603 indicates an image data from which a region having the least current consumption value is cropped from image data which is different from the image data shown in FIG. 6B.

When the remaining power of the battery is less than the threshold value, the electronic apparatus 100 may detect a current consumption value of at least one image data cropped as in FIG. 6B. When the detected current consumption value is not less than the threshold value, the electronic apparatus 100 may output a message popup window notifying that the image data is not able to be output in the slide show type due to remaining power shortage of the battery. When the detected current consumption value is less than the threshold value, the electronic apparatus 100 may output the cropped image data in the slide show type like FIG. 6C.

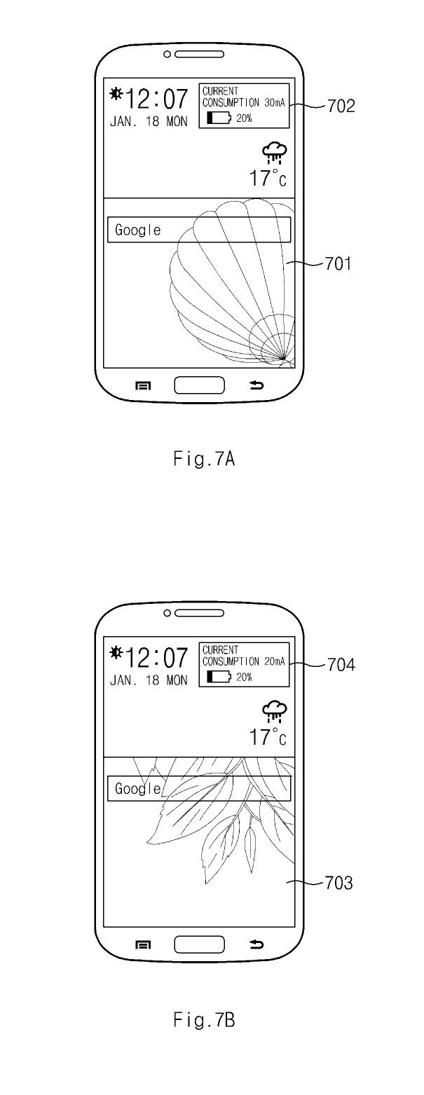

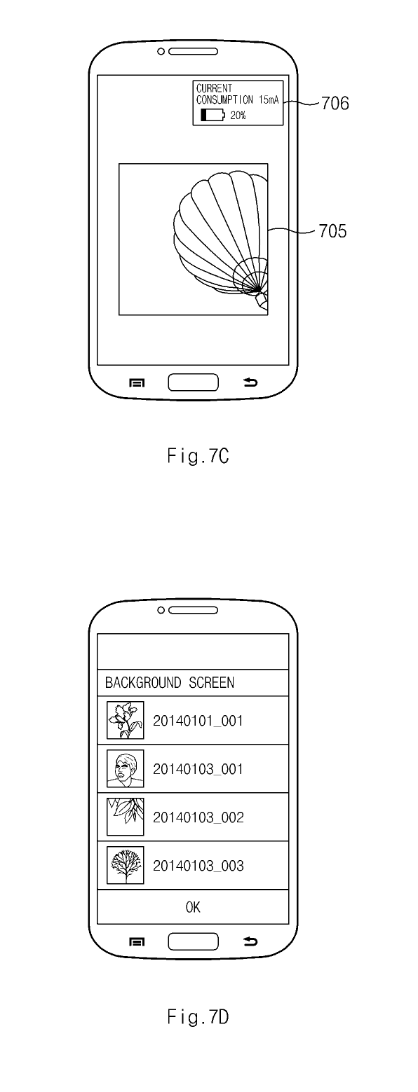

FIGS. 7A, 7B, 7C, and 7D are screen views illustrating an image data change with remaining power in a battery power saving mode according to an embodiment of the present disclosure.

Referring to FIGS. 1 and 7A, 7B, 7C, and 7D, when a background screen of the electronic apparatus 100 is set as in a reference numeral 701 of FIG. 7A, the electronic apparatus 100 may detect a current consumption value of image data corresponding to the reference numeral 701 and output it on the output module 130 as a reference numeral 702. At this point, the remaining power of the battery may be output in the reference numeral 702.

In an embodiment of the present disclosure, when the electronic apparatus 100 detects the remaining power of the battery in real time and the remaining power is less than a threshold value, the electronic apparatus 100 may change the image data as in a reference numeral 703 of FIG. 7B. The electronic apparatus 100 may detect a current consumption value of the changed image data and output it on the output module 130 as a reference numeral 704. For example, when the image data output as FIG. 7A is image data of bluish color that a current consumption value per unit time thereof is great, image data output as FIG. 7B may be image data of greenish or reddish color that a current consumption value per unit time thereof is less than that of the bluish color image data.

In an embodiment of the present disclosure, when the remaining power of the battery is less than a threshold value as a reference numeral 706, the electronic apparatus 100 may contract the image data as in a reference numeral 705 of FIG. 7C and output it on the output module 130. The output module 130 may output a current consumption value of the contracted image data and the remaining power of the battery. In an embodiment of the present disclosure, when the remaining power of the battery is less than a threshold value, the electronic apparatus 100 may output an image data list on the output module 130 as in FIG. 7D. At this point, the image data list may be a list of image data corresponding to a current consumption value less than that of the image data output as FIG. 7A. At this point, when any one image data is selected from among the image data list through a user input from outside, the electronic apparatus 100 may change a background screen into the selected image and output it.

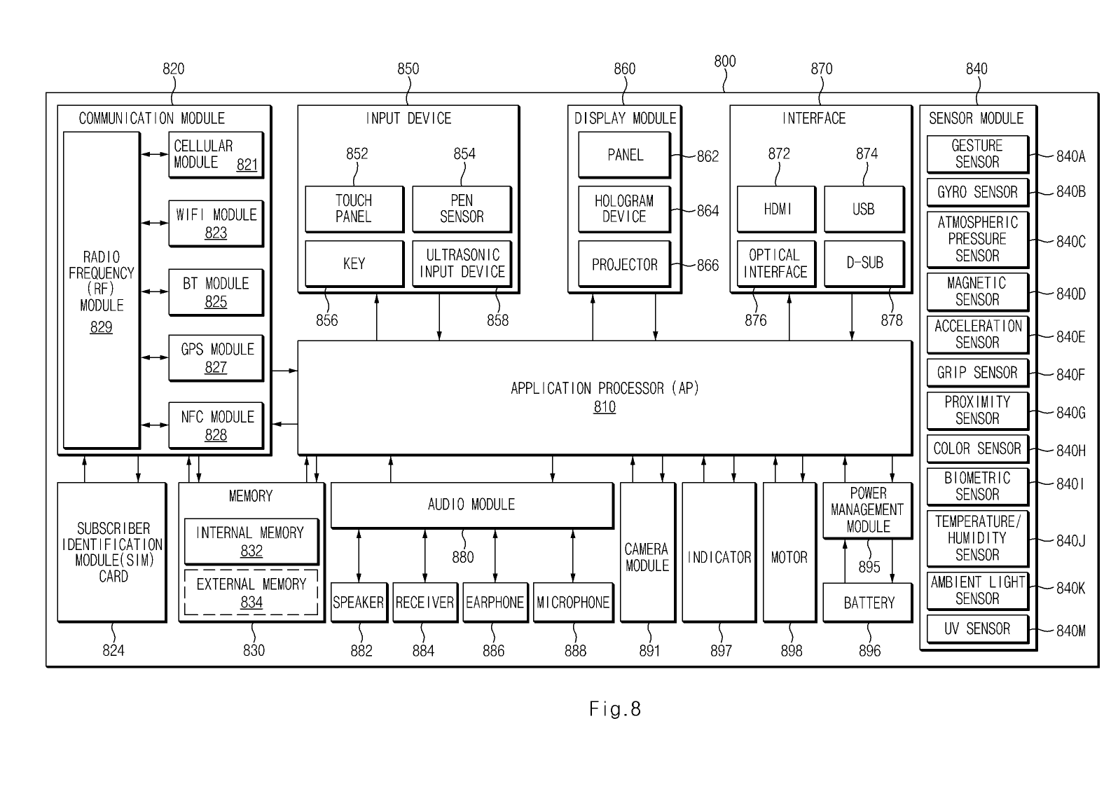

FIG. 8 is a block diagram illustrating an electronic device according to an embodiment of the present disclosure.

Referring to FIG. 8, an electronic device 800 may configure, for example, an entire or a part of the electronic apparatus 100 illustrated in FIG. 1.

Referring FIG. 8, the electronic device 800 may include at least one Application Processor (AP) 810, a communication module 820, a Subscriber Identification Module (SIM) card 824, a memory 830, a sensor module 840, an input device 850, a display module 860, an interface 870, an audio module 880, a camera module 891, a power management module 895, a battery 896, an indicator 897, or a motor 898.

The AP 810, for example, the control module 150 shown in FIG. 1, may drive an operating system or an application program and control a plurality of hardware or software elements connected thereto, and perform various data processing and operations including multimedia data. The AP 810 may be implemented with, for example, System on Chip (SoC). According to an embodiment of the present disclosure, the AP 810 may further include a Graphical Processing Unit (GPU, not shown). The AP 810 may, for example, detect current consumption for each pixel of at least one image data, calculate a current consumption value per unit time, and control an image data output.

The communication module 820, for example, the communication module 110 shown in FIG. 1, may perform data transmission and reception in communication between the electronic device 800 (e.g., the electronic apparatus 100) and other electronic devices connected through a network. According to an embodiment of the present disclosure, the communication module 820 may include a cellular module 821, a Wi-Fi module 823, a BT module 825, a GPS module 827, an NFC module 828, and a Radio Frequency (RF) module 829. The communication module 820 may receive at least one image data from an external device through a wired or wireless communication and provide it to the AP 810.

The cellular module 821 may provide a voice call, a video call, a text messaging service, or an Internet service, and the like, through a communication network (e.g., LTE, LTE-A, CDMA, WCDMA, UMTS, WiBro, or GSM, and the like). In addition, the cellular module 821 may identify or authenticate an electronic device in a communication network by using, for example, a subscriber identification module (e.g., the SIM card 824). According to an embodiment of the present disclosure, the cellular module 821 may perform at least a part of functions that the AP 810 may provide. For example, the cellular module 821 may perform at least a part of multimedia control function.

According to an embodiment of the present disclosure, the cellular module 821 may include a Communication Processor (CP). In addition, the cellular module 821 may be implemented with, for example, SoC. Although, in FIG. 10, the elements, such as the cellular module 821 (e.g., CP), the memory 830 and the power management module 895 are illustrated as being separate from the AP 810, the AP 810 may be implemented to include at least some (e.g., the cellular module 821) of the above-described elements.

According to an embodiment of the present disclosure, the AP 810 or the cellular module 821 (e.g., CP) may load, on a volatile memory, commands or data received from at least one of a nonvolatile memory and other elements and process them. Furthermore, the AP 810 or the cellular module 821 may store, in the nonvolatile memory, data received from or created by at least one of other elements.

The Wi-Fi module 823, the BT module 825, the GPS module 827 or the NFC module 828 may respectively include, for example, a processor for processing data transmitted or received through the corresponding module. Although, in FIG. 8, the cellular module 821, the Wi-Fi module 823, the BT module 825, the GPS module 827 or the NFC module 828 are illustrated as each separate block, at least some (e.g., at least two) of them may be included in a single Integrated Chip (IC) or an IC package. For example, at least some (e.g., a CP corresponding to the cellular module 821 and a Wi-Fi processor corresponding to the Wi-Fi module) of processors respectively corresponding to the cellular module 821, the Wi-Fi module 823, the BT module 825, the GPS module 827 or the NFC module 828 may be implemented as one SoC.

The RF module 829 may transmit and receive data, for example, an RF signal. Although not shown in the drawing, the RF module 829 may include, for example, a transceiver, a Power Amp Module (PAM), a frequency filter, or a Low Noise Amplifier (LNA), and the like. In addition, the RF module 829 may further include components, for example, a conductor or a wire for transmitting and receiving an electromagnetic wave in a free space in a wireless communication. Referring to FIG. 8, although the cellular module 821, the Wi-Fi module 823, the BT module 825, the GPS module 827 and the NFC module 828 are illustrated as sharing one RF module 829, at least one of the cellular module 821, the Wi-Fi module 823, the BT module 825, the GPS module 827 and the NFC module 828 may transmit and receive an RF signal through a separate RF module.

The SIM card 824 may be a card including a subscriber identification module and may be inserted into a slot formed at a specific position of the electronic device. According to various embodiments of the present disclosure, the SIM card 824 may be embedded in the electronic device in a chip type or stored in a part (e.g., an electronic SIM, virtual SIM, or soft SIM) of the corresponding electronic device without any physical form. The SIM card 824 may include unique identification information (e.g., Integrated Circuit Card Identifier (ICCID)) or subscriber information (e.g., International Mobile Subscriber Identity (IMSI)). The SIM card 824 may store at least one image data obtained in the camera module 891, and store at least one image data received from an external device through the communication module 820. The SIM card 824 may receive a current consumption value per unit time for each image data, map the received current consumption value per unit time to each stored image data, and store the mapped result. At this point, the SIM card 824 may store a current consumption value when image data is output in thumbnail type, a current consumption value when image data is cropped and output, a current consumption value when image data is output in full size on the display module 860. The full size may respectively indicate that the electronic device 800 is in a landscape mode or in a portrait mode.

The memory 830, for example, the storage module 140 of FIG. 1 may include an internal memory 832 or an external memory 834. The internal memory 832 may include at least one of, for example, a volatile memory (e.g., a Dynamic Random Access Memory (DRAM), a Static RAM (SRAM), a Synchronous Dynamic RAM (SDRAM), and the like) or a nonvolatile memory (e.g., a One time Programmable ROM (OTROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, and the like). The memory 830 may store at least one image data obtained in the camera module 891, and store at least one image data received from an external device through the communication module 820. The memory 830 may store a current consumption value per unit time for each image data which is received and mapped to each stored image data. At this point, the memory 830 may store a current consumption value when image data is output in thumbnail type, a current consumption value when image data is cropped and output, a current consumption value when image data is output in full size on the display module 860. The full size may respectively indicate that the electronic device 800 is in a landscape mode or in a portrait mode.

In an embodiment of the present disclosure, the internal memory 832 may be a Solid State Drive (SSD). The external memory 834 may further include a flash drive, for example, Compact Flash (CF), Secure Digital (SD), micro-Secure Digital (micro-SD), mini Secure Digital (mini-SD), extreme Digital (xD), or a memory stick. The external memory 834 may be functionally connected to the electronic device 800 through various interfaces. According to an embodiment of the present disclosure, the electronic device 800 may further include a storage device (or storage medium) like a hard drive.

The sensor module 840 may measure a physical quantity or detect an operating state of the electronic device 800, and convert the measured or detected information into an electrical signal. The sensor module 840 may include at least one of, for example, a gesture sensor 840A, a gyro sensor 840B, an atmospheric pressure sensor 840C, a magnetic sensor, 840D, an acceleration sensor 840E, a grip sensor 840F, a proximity sensor 840G, a color sensor 840H (e.g., RGB sensor), a biometric sensor 840I, a temperature/humidity sensor 840J or an ambient light sensor 840K, and an Ultra Violet (UV) sensor 840M. Additionally or alternatively, the sensor module 840 may include, for example, a e-nose sensor (not shown), an Electromyography (EMG) sensor (not shown), an Electroencephalogram (EEG) sensor (not shown), an Electrocardiogram (ECG) sensor (not shown), an Infra-Red (IR) sensor (not shown), an iris sensor (not shown), or a fingerprint sensor (not shown), and the like. The sensor module 840 may further include a control circuit for controlling at least one sensor therein.

The input device 850, for example, the input module 120 shown in FIG. 1, may include a touch panel 852, a (digital) pen sensor 854, a key 856, or an ultrasonic input device 858. The touch panel 852 (e.g., the output module 130) may recognize a touch input in at least one of capacitive, pressure-sensitive, infra-red ray, and surface acoustic wave type. In addition, the touch panel 852 may further include a control circuit. In case of capacitive type, physical contact or proximity recognition is possible. The touch panel 852 may further include a tactile layer. In this case, the touch panel 852 may provide a tactile reaction to the user. The input device 850 may create an arrangement signal for arranging image data based on current consumption when the image data list for at least one image data is output. The input device 850 may create an entering signal for entering a battery power saving mode. The input device 850 may create an enlargement signal for enlarging image data displayed on the display module 860. The input device 850 may create an entering signal for detecting stored image data in a slide show type.

The (digital) pen sensor 854 may be implemented, for example, in a similar or same manner as the method of receiving a touch input of a user or may be implemented using an additional sheet for recognition. The key 856 (e.g., the input module 120) may include, for example, a physical button, an optical button, or a keypad. The ultrasonic input device 858, which is an input device for generating an ultrasonic signal, may enable the electronic device 800 to detect a sound wave through a microphone so as to identify data, wherein the ultrasonic input device 858 is capable of wireless recognition. According to an embodiment of the present disclosure, the electronic device 801 may use the communication module 820 so as to receive a user input from an external device (e.g., a computer or server) connected to the communication module 820.

The display module 860, for example, the output module 130 shown in FIG. 1, may include a panel 862, a hologram device 864 or a projector 866. The panel 862 may be, for example, a liquid crystal display or an AMOLED. The panel 862 may be implemented as, for example, flexible, transparent or wearable. The panel 862 may be configured as one module with the touch panel 852. The hologram device 1064 may show a stereoscopic image in the air by using interference of lights. The projector 866 may display an image by projecting a light on a screen. The screen may be located, for example, inside or outside the electronic device 800. According to an embodiment of the present disclosure, the display module 860 may further include a control circuit for controlling the panel 862, the hologram device 864, or the projector 866. When the display module 860 includes an AMOLED display, current consumption values may be differed according to RGB values corresponding to pixels of output image data. When including a touch screen, the display module 860 may create various input signals for controlling operations of the electronic device 800. The display module 860 may output a current consumption value of image data output under a control of the AP 810 and remaining power of a battery.

The interface 870 may include, for example, a HDMI, 872, a USB 874, an optical interface 876 or a D-subminiature (D-sub) 878. Additionally or alternatively, the interface 870 may include, for example, a Mobile High-definition Link (MHL) interface, a SD card/Multimedia Card (MMC) interface, or an Infrared Data Association (IrDA) specification interface.

The audio module 880 may convert sound into an electrical signal, or vice versa. The audio module 880 may process sound information input from or output to, for example, a speaker 882, a receiver 884, an earphone 886, or a microphone 888.

The camera module 891 is a device for capturing a still image or a video, and, may include at least one image sensor (e.g., a front side sensor or a rear side sensor), a lens (not shown), an Image Signal Processor (ISP, not shown), or a flash (not shown) (e.g., an LED or a xenon lamp).

The power management module 895 may manage power of the electronic device 80. Although not shown in the drawing, the power management module 895 may include, for example, a Power Management Integrated Circuit (PMIC), a charger integrated circuit, or a battery or a fuel gauge.

The PMIC may be embedded, for example, in an IC or inside a SoC. A charging scheme may be divided into a wireless and wired scheme. The charging IC may charge the battery and block inflow of over-voltage or over-current from a charger. According to an embodiment of the present disclosure, the charging IC may include a charging IC for at least one of wired charging scheme or wireless charging scheme. As the wireless charging scheme, for example, there is a magnetic resonance scheme, inductive coupling scheme, or microwave scheme. An additional circuit, for example, a coil loop, a resonance circuit, a rectifier, and the like, may be further included for wireless charging.

The battery gauge may measure, for example, remaining of the battery 896, voltage, current or temperature while in charging. The battery 896 may store or generate electricity and supply power to the electronic device 800 using the stored or generated electricity. The battery 896 may include, for example, a rechargeable battery or solar battery.

The indicator 897 may display a specific state of the electronic device 800 or a part thereof (e.g., the AP 810), for example, a booting state, a message state, a charging state, and the like. The motor 898 may convert an electrical signal into a mechanical vibration. Although not shown in the drawing, the electronic device 800 may include a processing device (e.g., a GPU) for supporting a mobile TV. The processing device for supporting the mobile TV may process media data complying with specifications, such as Digital Multimedia Broadcasting (DMB), Digital Video Broadcasting (DVB), media flow, and the like.

Each of the above-described elements of an electronic device may be configured with one or more components, and a name of a corresponding element may vary according to a kind of electronic device. An electronic device may include at least one element among the above-described elements and some elements may be omitted or additional other elements may be further included. Furthermore, some of elements of an electronic device may be combined to be one entity and perform the same functions as those of corresponding elements before the combination.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” according to various embodiments of the present disclosure may include at least one of an Application-Specific Integrated Circuit (ASIC) chip, a Field-Programmable Gate Array (FPGA), and a programmable-logic device for performing some operations, which are known or will be developed. According to various embodiments of the present disclosure, at least a part of devices (e.g., modules or functions thereof) or methods (e.g., operations) according to various embodiments of the present disclosure may be implemented as instructions stored in a computer-readable storage medium in the form of a programming module. In the case where the instructions are performed by at least one processor, the at least one processor may perform functions corresponding to the instructions. The computer-readable storage medium may be, for example, a memory. At least a part of the programming module may be implemented (e.g., executed) by the processor. At least a part of the programming module may include, for example, a module, program, routine, sets of instructions, or process for performing at least one function.

The computer-readable storage medium may include a magnetic medium, such as a hard disk, a floppy disk and a magnetic tape, an optical medium, such as a Compact Disk Read Only Memory (CD-ROM) and a DVD, a magneto-optical medium, such as a floptical disk, and a hardware device configured to store and execute program instructions (e.g., programming module), such as a Read Only Memory (ROM), a Random Access Memory (RAM) and a flash memory. The program instructions may include machine language codes made by compilers and high-level language codes that can be executed by computers using interpreters. The above-mentioned hardware may be configured to be operated as one or more software modules for performing operations of various embodiments of the present disclosure and vice versa.

The module or programming module according to various embodiments of the present disclosure may include at least one of the above-mentioned elements, or some elements may be omitted or other additional elements may be added. Operations performed by the module, the programming module or the other elements may be performed in a sequential, parallel, iterative or heuristic way. Furthermore, some operations may be performed in another order or may be omitted, or other operations may be added.

An image data output control apparatus and method using current consumption according to various embodiments of the present disclosure can address the inconvenience experienced by a user due to brightness adjustment by controlling a method of outputting image data using the characteristics of an output module having different current consumptions according to an RGB value for each pixel of the image data.

Furthermore, an image data output control apparatus and method using current consumption according to various embodiments of the present disclosure can perform a battery power saving mode by controlling a method of outputting image data according to a current consumption value per unit time of the image data and a remaining power value of an electronic device.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An apparatus for controlling image data output using current consumption, the apparatus comprising:
a control module configured to detect current consumption for each pixel for at least one image data, to calculate a current consumption value per unit time, and to control an output of the image data; and
an output module configured to output the image data.

2. The apparatus of claim 1, wherein the control module is further configured to arrange the at least one image data based on the current consumption value when entering a battery power saving mode.

3. The apparatus of claim 1, wherein the control module is further configured to detect remaining power of the battery when entering the battery power saving mode.

4. The apparatus of claim 3, wherein the control module is further configured to control enlargement of the image data according to a current consumption value at the time of enlarging the image data, when an enlargement signal of the image data is received and the remaining power is less than a threshold value.

5. The apparatus of claim 4, wherein, when the current consumption value of the enlarged certain part is not less than the threshold value, an image managing unit is configured to enlarge image data, and wherein the output module is further configured to output a message popup window notifying that the image data is not able to be enlarged due to battery shortage.

6. The apparatus of claim 3, wherein the control module is further configured to control rotation of the image data according to a current consumption value before and after rotation of the image data, when an output module rotation signal is received and the remaining power is less than a threshold value.

7. The apparatus of claim 3, wherein the control module is further configured to change the image data into other image data having a current consumption value less than that of the image data, when the remaining power is less than a threshold value.

8. The apparatus of claim 3, wherein the control module is further configured to contract the image data, when the remaining power is less than a threshold value.

9. The apparatus of claim 3, wherein the control module is further configured to crop a region having a least current consumption value in the at least one image data, when a request signal for a slide show for the at least one image data is received.

10. The apparatus of claim 3, wherein the output module is further configured to output the remaining power and the current consumption value.

11. A method for controlling image data output using current consumption, the method comprising:
detecting, by a control module, current consumption for each pixel for at least one image data;
calculating by the control module, a current consumption value per unit time based on the current consumption; and
controlling, by the control module, an output of the image data according to the current consumption value.

12. The method of claim 11, further comprising, after the calculating of the current consumption value, detecting, by the control module, remaining power of a battery.

13. The method of claim 12, wherein the controlling of the output of the image data comprises controlling, by the control module, the output of the image data with at least one of change and contraction of the image data, when the remaining power is less than a threshold value.

14. The method of claim 12, wherein the controlling of the output of the image data comprises receiving, by the control module, an output control signal of the image data, and
wherein, when the remaining power is not less than a threshold value, the control module outputs the image data according to the output control signal.

15. The method of claim 14, wherein the controlling of the output of the image data comprises detecting, by the control module, the current consumption value of the image data according to the output control signal, when the remaining power is less than the threshold value,
wherein the control module outputs a message notifying that an output control of the image data is not available, when the current consumption value is not less than a threshold value, and wherein the control module controls an output of the image data according to the output control signal, when the current consumption value is less than the threshold value.

16. The method of claim 15, further comprising controlling enlargement of the image data according to a current consumption value at the time of enlarging the image data, when an enlargement signal of the image data is received and the remaining power is less than a threshold value.

17. The method of claim 16, wherein, when the current consumption value of the enlarged certain part is not less than the threshold value, enlarging image data and outputting a message popup window notifying that the image data is not able to be enlarged due to battery shortage.

18. The method of claim 11, further comprising entering, by the control module, a battery power saving mode according to an external signal, before the detecting of the current consumption for each pixel.
